(19) United States
(12) Patent Application Publication
(10) Pub. No.: US 2013/0024362 A1
(43) Pub. Date: Jan. 24, 2013

(54) PROCESSING CODED DATA

(71) Applicants: Maarten Lossie, Amsterdam (NL); Joerg Pinkernell, Frankfurt (DE); Keith Tayler, Colchester (GB); Susan Hall, Beilen (NL)

(72) Inventors: Maarten Lossie, Amsterdam (NL); Joerg Pinkernell, Frankfurt (DE); Keith Tayler, Colchester (GB); Susan Hall, Beilen (NL)

(21) Appl. No.: 13/380,107

(22) PCT Filed: Jun. 30, 2009
(86) PCT No.: PCT/EP2009/058193

§ 371 Date: Jul. 12, 2012

(51) Int. Cl. G06Q 40/00

(52) U.S. Cl. 705/39

(57) ABSTRACT

A data processing system processes coded data having data fields representing a financial transaction involving currency conversion. A database contains data relating to beneficiaries of financial transactions and other criteria. A communications interface interfaces with a secure financial communications system. The data processing arrangement analyses the data fields of coded data received from the communications system, and identifies from the fields and data in the database whether or not the transaction complies with the said criteria thereby indicating whether the transaction is a candidate for currency conversion. If currency conversion is carried out data fields relating to the currency and value of the currency are changed. Data in data fields relating to the addressing of the coded data is changed to indicate the address of another data processing system. The coded data is transmitted via the secure communications system to the other data processing system.

### BACKGROUND OF THE INVENTION

1. Field of the Invention

The present invention relates to a data processing system for processing coded data. The present invention also relates to a method of processing such coded data and to a computer program or programs for processing such data.

2. Description of the Prior Art

Coded data is used to provide data relating to, or representing, financial transactions in financial systems. A well known example of a communications system used by financial institutions is the SWIFT system. SWIFT is the Society for Worldwide Interbank Financial Telecommunications which provides secure messaging services for financial Institutions: see www.swift.com. SWIFT defines standards for coding data known as swift codes representing a financial transaction. The swift codes are messages providing data about financial transactions and are communicated by the SWIFT communications system between financial institutions. The value or money of a financial transaction is transferred between financial institutions by other known systems such as clearing systems or by other known settlement systems: see for example US 2003/0236726 A1. An example of a settlement system is RTGS (Real Time Gross Settlement) which is used for high value and/or urgent transactions and involves the use of a Central Bank. Another example is ACH (Account Clearing House), for example BACS in the UK, which is used for low value low urgency transaction which are usually batch processed.

In the USA, there are other secure communications systems used by US financial institutions such as Fedwire: see for example US 2003/0236726 A1.

International financial transactions may or may not involve the conversion of one currency to another. It is known to transfer for example US Dollars (USD) from a financial institution in USA to another in for example the UK without conversion but it is also known for a US financial institution, e.g. a US Bank, to provide USD but the UK institution, e.g. a UK Bank, to require GB Pounds sterling (GBP) so a currency conversion takes place. SWIFT codes allow messages concerning such transactions to be sent between the banks and allow settlement by a suitable settlement scheme.

A Bank may have a banking relationship with another Bank either by the setting up of accounts with each other—each bank having an account with the other—or in other known ways. However a Bank may have such a relationship with only a small number of other Banks If a transaction involves two Banks which do not have a relationship, then one of more intermediaries which do have the required relationships are used. It is common practice that, for example, a US bank does not have a banking relationship with a UK bank so an intermediary with which it does have a relationship is used to transfer the value or money to the UK bank. So it is known to use an intermediary or even a chain of intermediaries: see for example US 2003/0208440 A1 and US 2003/0236726 A1. Currency conversion may occur at the US bank or at the UK bank or may not be required at all. Each institution in the chain must determine what action to take. This introduces inefficiencies. In addition each institution in the chain may levy a fee for dealing with the transaction increasing the cost of the transaction. Furthermore a Bank which originates transactions may have many transactions with many different beneficiaries in different countries thus potentially involving many different currencies without banking relationships with the beneficiary banks.

It is desirable to improve the efficiency of the system for carrying out financial transactions which potentially involve currency conversions.

### SUMMARY OF THE INVENTION

According to one aspect of the present invention, there is provided a data processing system for processing coded data having a plurality of data fields representing a financial transaction potentially involving currency conversion, the system comprising:

a data processing arrangement including a database containing data relating to beneficiaries of financial transactions and other predetermined criteria;

a communications interface arrangement for interfacing with a secure financial communications system for transmitting coded data from the data processing arrangement to the communication system and transmitting coded data from the communications system to the data processing arrangement;

the data processing arrangement being arranged to

analyse the data fields of coded data received from the communications system,

identify from the analysed coded data fields and data in the database whether the transaction complies at least with the predetermined criteria and criteria relating to the beneficiary whether or not to carry out currency conversion;

if currency conversion is carried out, change data in the data fields relating to the currency and value of the currency and, whether or not currency conversion is carried out, change data in data fields relating to the addressing of the coded data; and

send the coded data as so changed to the communications interface arrangement for transmission via the secure communications system to the address specified in the data fields relating to the addressing of the coded data.

According to an embodiment of the present invention there is provided a data processing system for processing coded data having a plurality of data fields representing a financial transaction potentially involving currency conversion, the system comprising:

a data processing arrangement including a database containing data relating to beneficiaries of financial transactions and other predetermined criteria;

a communications interface for interfacing with a secure financial communications system for transmitting coded data from the data processing arrangement to the communication system and transmitting coded data from the communications system to the data processing arrangement;

the data processing arrangement being arranged to

analyse the data fields of coded data received from the communications system,

identify from a first set of the fields and data in the database related to the said predetermined criteria whether or not the transaction as represented by the data in that first set of fields complies with the said predetermined criteria thereby indicating whether or not the transaction is a candidate for currency conversion,

identify from a second set of the fields and related data in the database concerning the beneficiary whether or not the transaction is a candidate for currency conversion to carry out the currency conversion,

carry out currency conversion if the both the first and second sets of fields indicate the transaction is a candidate for currency conversion,

if currency conversion is carried out, change data in the data fields relating to the currency and value of the currency and, whether or not currency conversion is carried out, change data in data fields relating to the addressing of the coded data, and

send the coded data as so changed to the communications interface for transmission via the secure communications system to the address specified in the data fields relating to the addressing of the coded data.

In an implementation of the system, the system acts as an intermediary between originators of transaction and beneficiaries. There can be very large numbers of transactions between for example one originator and many beneficiaries. There can be large numbers of originators. The transactions vary and any one transaction between a particular originator and a particular beneficiary may or may not require currency conversion. An originator may require the intermediary to carry out conversion in some circumstances but not in others. Furthermore, particular beneficiaries may object to currency conversion being carried out or may object to a particular intermediary carrying out the conversion. The present invention provides a technical process of analysing and changing coded data using a data processing system and a communications interface which enables an intermediary to automatically determine from received coded data whether or not to carry out currency conversion taking account of criteria which for example satisfy originators and satisfying beneficiaries and to automatically change the coded data to forward the coded data to another institution, for example the beneficiaries bank or, in another example, another institution in a chain of intermediaries. This increases the efficiency of dealing with transactions that require currency conversion.

In an embodiment, the identification from the first set of the fields and data in the database related to the said predetermined criteria whether or not the transaction as represented by the data in that first set of fields complies with the said predetermined criteria thereby indicating whether or not the transaction is a candidate for currency conversion, precedes the identification from the second set of the fields and related data in the database concerning the beneficiary whether or not the transaction is a candidate for currency conversion to carry out the currency conversion. In another embodiment the identification from the second set of the fields and related data in the database concerning the beneficiary whether or not the transaction is a candidate for currency conversion to carry out the currency conversion precedes the identification based on the first set of fields.

In an embodiment, the data processing arrangement comprises a first plurality of data processors each having a communications interface for interfacing with the secure financial communications system for transmitting coded data from the first data processor to the communication system and transmitting coded data from the communications system to the first data processor, the first data processor being arranged to identify from a set of the fields relating to the currency involved in the transaction and to fields of the first set relating to the destination account holding institution whether or not the transaction is a candidate for currency conversion, and having established the transaction is such a candidate change data in data fields relating to the addressing of the coded data; and send the coded data as so changed to the communications interface for transmission via the secure communications system to a predetermined address which is specified in the data fields relating to the addressing of the coded data; and,

at the said predetermined address, a further data processor having a communications interface operable to receive coded data from all the data processors of the said first plurality for processing coded data relating to any candidate transaction received from the first plurality of processors,

the further data processor including the said database containing data relating to beneficiaries of financial transactions and other predetermined criteria

the further processor being arranged to process each received candidate transaction to establish from data relating to said predetermined criteria stored in the data base and data of one set of relevant fields whether the candidate complies with the said criteria,

determining from another set of fields and data in the database relating to the beneficiary, whether or not to carry out currency conversion,

carry out currency conversion if the one and another sets of fields indicate the transaction is a candidate for currency conversion,

if currency conversion is carried out, change data in the data fields relating to the currency and value of the currency and, whether or not currency conversion is carried out, change data in data fields relating to the addressing of the coded data; and

send the coded data as so changed to the further communications interface arrangement for transmission via the secure communications system to a further address specified in the data fields relating to the addressing of the coded data.

Thus conversion of currency is concentrated at the further data processor.

These and other aspects of the invention are specified in the claims to which attention is invited.

### BRIEF DESCRIPTION OF THE DRAWINGS

For a better understanding of the present invention, reference will now be made by way of example to the accompanying drawings in which:

FIG. 1 is an overview of a financial communications system including a data processing system for processing coded data in accordance with an embodiment of the present invention

FIG. 2 is a schematic diagram of an example of the use of the system of FIG. 1 applied to one transaction between banks of FIG. 1;

FIG. 3A and FIG. 3B are schematic block diagrams of data processing apparatus used in the system of FIGS. 1 and 2;

FIG. 4 is a diagram showing SWIFT codes and examples of changes made to such codes in operation of the transaction of FIG. 2;

FIG. 5 is a flow chart of a first part of an illustrative procedure for determining whether a transaction is a candidate for currency conversion;

FIG. 6 is a flow chart of a second part of the illustrative procedure for determining whether a transaction is a candidate for currency conversion;

FIG. 7 is a flow chart of showing more detail of a portion of the second part of the procedure; and

FIG. 8 is a flow chart illustrating another portion of the second part of the procedure; and

FIG. 9 is a schematic diagram of another example of a financial communications system including data processing system for processing coded data in accordance with another embodiment of the present invention.

### DESCRIPTION OF ILLUSTRATIVE EMBODIMENTS OF THE INVENTION

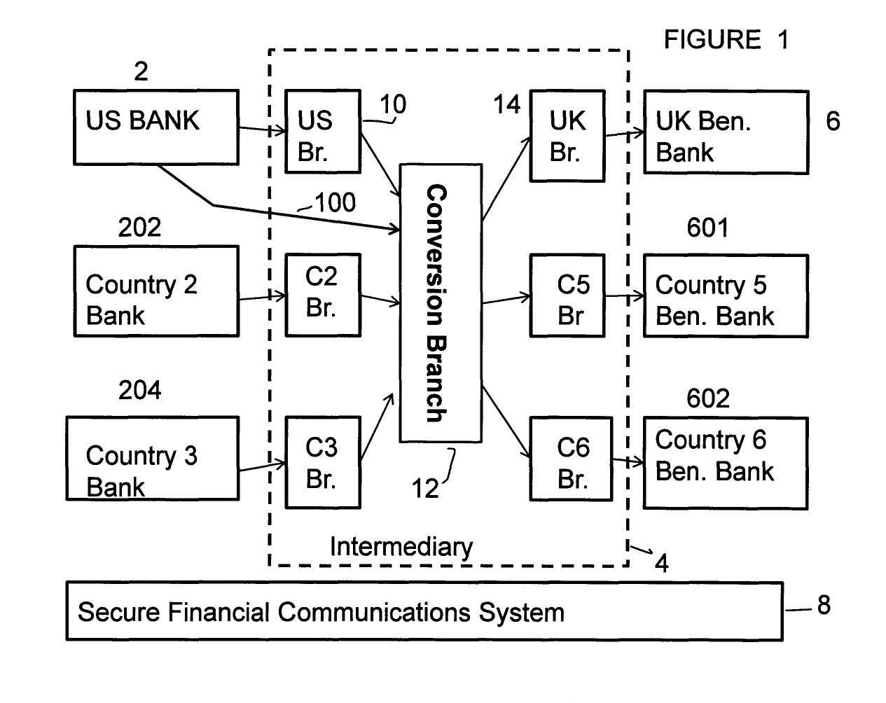

Overview of FIG. 1.

An intermediary 4 has a branch network with branches in many countries as indicated by way of example in: USA (USBr) 2; UK, (UKBr.) 6; and branches C2Br, C3Br., C5Br, and C6Br in other countries. Each branch has a relationship with a domestic bank for example US Bank 2, UK Bank 6 and other banks 202, 204, 601 and 602. The banks 2, 202, 204, 6, 601 and 602 and the branches 10, 14, C2Br. To C6Br. use a secure financial communications system 8 to send and receive coded data representing transactions to each other. The secure communications system is known and may be SWIFT or a combination of SWIFT and other systems for example Fedwire in the USA and other systems used in for example European countries.

In the example of FIG. 1, the Banks 2, 202 and 204 have agreements with the intermediary 4 to send, via the intermediary's branches in their respective countries, transactions which may involve currency conversion. The branches 10, C2Br., C3Br. receive coded data representing the transactions and send coded data relating to transactions which may involve currency conversion to a conversion branch 12 of the intermediary. In the example of FIG. 1 all such transactions are dealt with by the conversion branch 12 of the intermediary 4. The conversion branch does a currency conversion on a transaction which complies with predetermined conditions and sends the converted transaction to the branch 14, C5Br. C6Br. in the country of the beneficiary. Thus all transactions which are candidates for currency conversion are concentrated in the conversion branch 12.

The system of FIG. 1 allows any currency to be converted to any other currency. For example conversion could take place between any of the following currencies:

AED
AUD
CAD
CHF
CZK
DKK
EEK
EUR
GBP
HKD
HUF
INR
ISK
JPY
LTL
LVL
MAD
MXN
NOK
NZD
PLN
RON
RUB
SAR
SEK
SGD
THB
TND
TRY
USD
ZAR

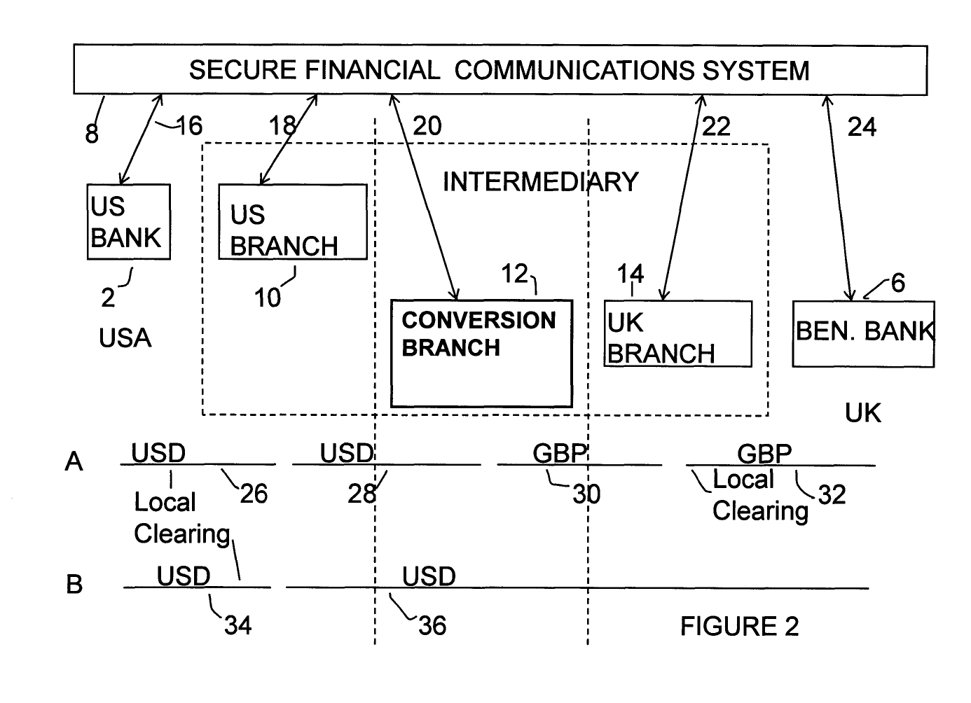

In practice, only a limited set of currencies may be processed by this system for example US Dollars (USD), British Pounds (GBP), EUROs (EUR), Yen, and some other major currencies. The system of FIG. 2 is not suitable for some countries because local Banking rules would not allow it to be used.

The branches of the intermediary 4 have data processors and communications hardware and automatically process the coded data representing transactions as will be described hereinbelow. Settlement of transactions between banks and branches and between branches of the intermediary is done in conventional ways which are well known in the art and will not be described herein.

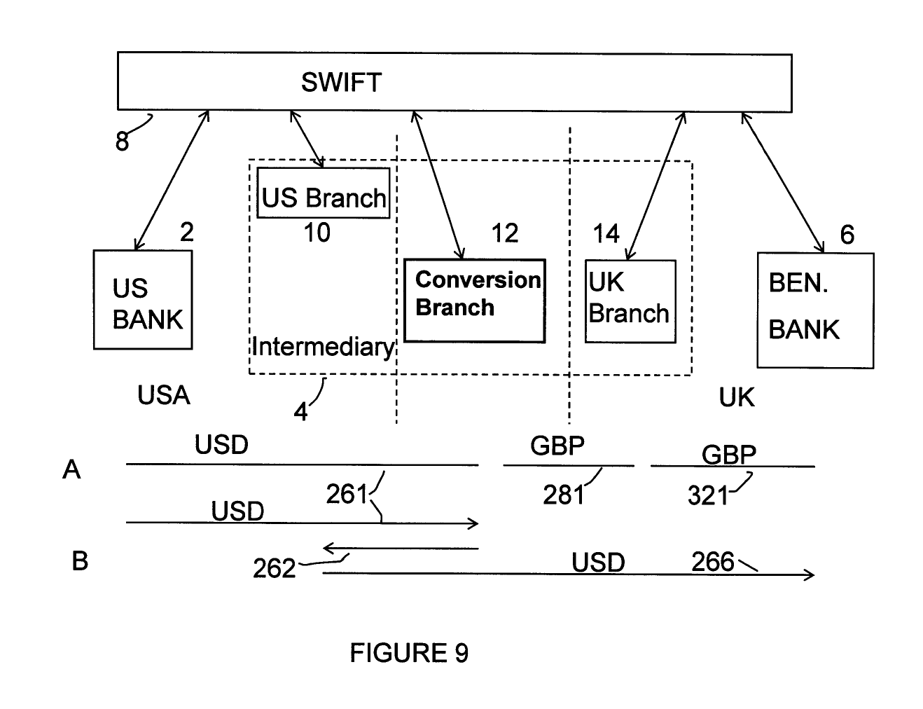

As indicated by line 100 in another example of the system, the US Bank 2 communicates directly with the conversion branch 12 via the secure financial communications system 8. In this example, any of the banks 2, 202, 204 which have a banking relationship with the conversion branch sends transactions directly to the intermediary without using a branch of the intermediary in their country. This example is described in more detail below with reference to FIG. 9.

The system of FIG. 1, whether operating so that the Banks 2, 2022 and 204 communicate via the branches 10, C2Br and C3Br or operating with the Banks 2, 202, 204 communicating directly with the conversion branch concentrates conversion services within the conversion branch.

### First Example

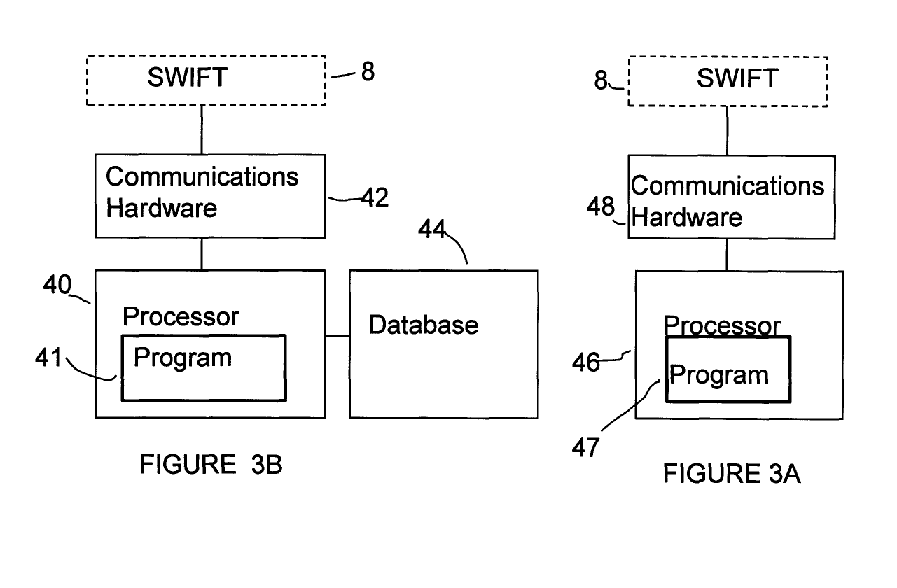

FIG. 2 illustrates the system and the processing of a transaction between the US Bank 2 and the UK Bank 6 of FIG. 1 using the intermediary 4. Transactions between the other banks for example Bank 204 and Bank 601 using branches of the intermediary would be processed in the same way. The other Banks and other branches would have data processors and communications hardware similar to those of FIGS. 2, 3A and 3B.

In this example, we assume for the sake of illustration a transferor, who may be a customer of the US bank 2, wishes to transfer money from the USA to a beneficiary John Doe in the United Kingdom (UK). The transferor requests the US bank 2 to initiate the transfer. The US bank has an agreement with the intermediary 4 under which the intermediary 4 handles the transfer to the beneficiary's bank 6 in the UK. The intermediary is a bank in this example. In this example, the intermediary has the branch 10 in the USA and the branch 14 in the UK. The intermediary has the branch 12 which processes all transactions requiring currency conversion. The branch 12 may be in Germany for example but could be anywhere else. The banks 2 and 6 and the branches 10, 12 and 14 communicate via the secure financial communications system 8. In this example the communications system is the SWIFT system. In the USA, the US bank 2 may communicate with the US branch 10 via Fedwire or Chips ACH. The banks and branches communicate with the SWIFT system via communication links 16 to 22.

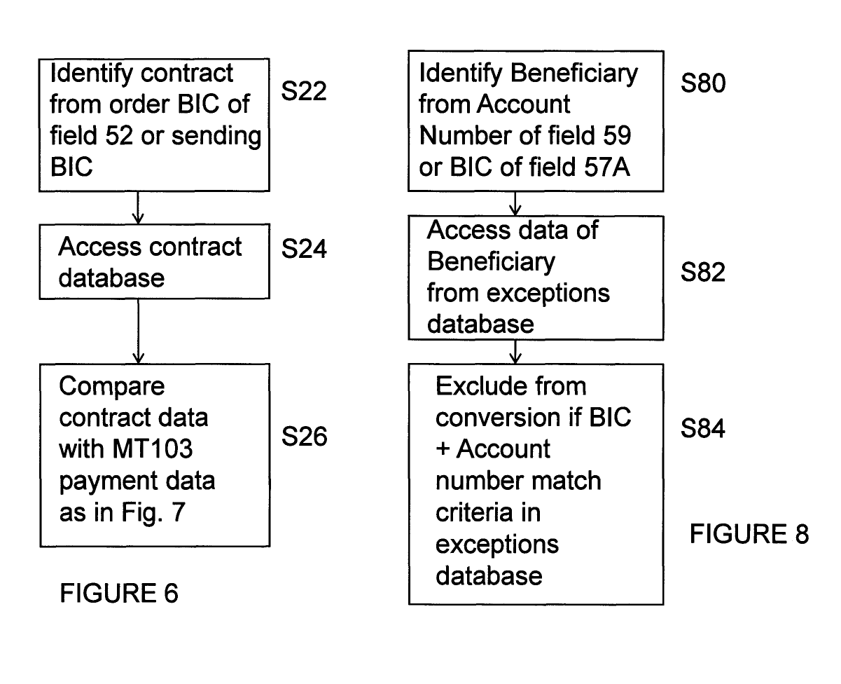

The US bank 2 has a contract with the intermediary 4. The details of the contract are stored in a database (see 71 in FIG. 7B) at the conversion branch 12 as will be described in more detail with reference to FIGS. 6 and 7.

The process of transferring money from the US bank 2 to the beneficiary's bank 6 involves:

a) the sending of messages complying with SWIFT MT103; and

b) the transfer of value.

SWIFT MT103 messages do not themselves transfer value: they convey information about the transaction involving the transfer of value.

The following description firstly describes the processing of SWIFT messages. The transfer of value is well known and is not described herein.

Referring to FIG. 3A, the US bank 2, the US branch 10, the UK branch 14 and the beneficiary bank 6 each have a data processor 46 linked to the SWIFT system 8 via communications hardware 48. The processor 46 and hardware 48 may be conventional. Referring to FIG. 3B, the conversion branch 12 has a data processor 40 linked to the SWIFT system via communications hardware 42, which may be conventional. The conversion branch also has a database 44 which may be hosted by the processor 40 or by another processor. The data processors 40 and 46 in the banks and branches process SWIFT messages as will be described hereinafter by way of example.

The US branch 10 may also have a database hosted on its processor 46 or on another processor similar to the conversion branch.

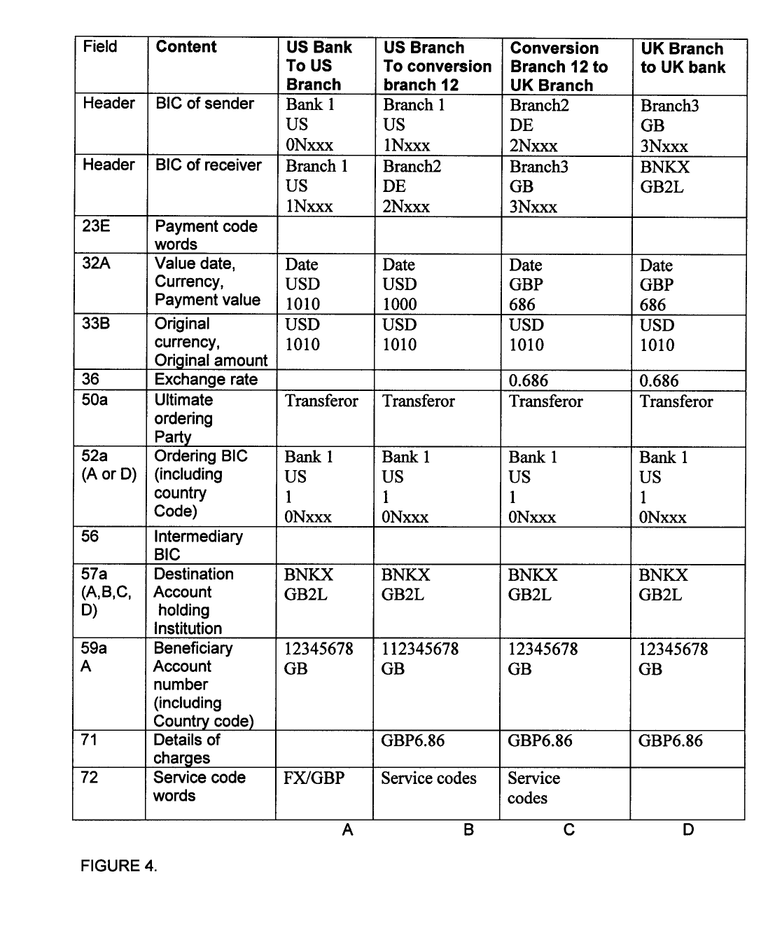

Referring to FIG. 4, the column denoted “Field” lists some of the fields of a SWIFT MT 103 message. The fields indicated are those fields of relevance to this example of the invention. A SWIFT message has other fields some of which are mandatory but which are not shown in FIG. 4. The column denoted “Content” describes the contents of the fields.

| Field | Content |
|---|---|
| Header | BIC of sender |
| Header | BIC of receiver |
| 23E | Payment code words |
| 32A | Value date, |
| | Currency, |
| | Payment value |
| 33B | Original currency, |
| | Original amount |
| 36 | Exchange rate |
| 50a | Ultimate ordering |
| | Party |
| 52a | Ordering BIC |
| (A or D) | (including country |
| | Code) |
| 56 | Intermediary BIC |
| 57a | Destination Account |
| (A, B, C, D) | holding Institution |
| 59a A | Beneficiary |
| | Account number (including |
| | Country code) |
| 71 | Details of charges |
| 72 | Service code |
| | words |

BIC is the Bank Identification Code which is unique to a a Bank and also its associated data processor. It may be regarded as the address of the data processor of a the Bank identified by the BIC.

The ultimate ordering party is the name of the transferor who is for example the customer of the US Bank 1.

Field 52a may contain contents A or D where A is a valid BIC code and D is a sort code or the name of a bank where the BIC is not known. Field 57 may contain contents A, B, C or D- where A is a valid BIC code and/or sort code and B, C and D are a valid BIC code and/or sort code and/or other forms of identification such as the name and/or address of the bank. Field 59a may contain content with the ‘no letter option’ or option A—where the no letter option includes the identifier of the beneficiary of the payment indicated with a BBAN (Basic Bank Account Number), IBAN (International Bank Account Number) and/or the name of the beneficiary and where option A contains the identifier of the beneficiary of the payment using a BIC code or BEI code (Business Entity Identifier). In FIG. 4 the BICs indicated are merely illustrative and do not represent “real” codes.

Referring to FIG. 1 and column A of FIG. 4, the US bank 2 sends a SWIFT message to the US branch 10 of the intermediary 4. The form of the message is illustrated in column A of FIG. 4. From the point of view of the intermediary, the intermediary does not know whether or not a currency conversion will be required until it has analysed the contents of the message. To determine whether or not to carry out a currency conversion, the intermediary carries out three processes.

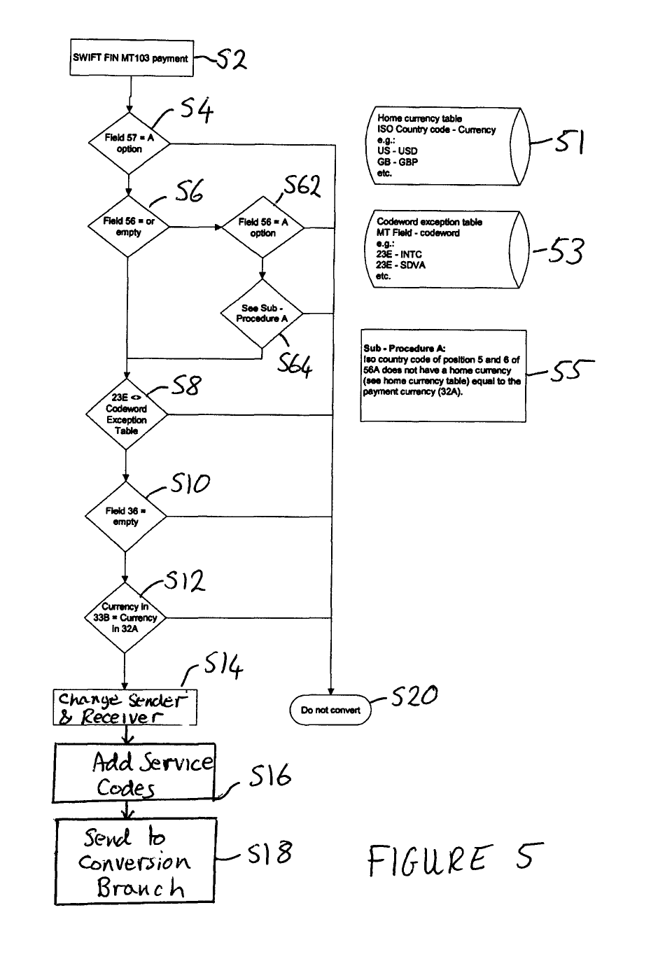

Process 1 determines whether the transaction represented by the message is a candidate for currency conversion by identifying from a set of the fields relating to the currency involved in the transaction and to fields of the first set relating to the destination account holding institution whether or not the transaction is a candidate for currency conversion. In this example the set of fields is fields 57, 56, 23E, 33B and 32A. An example of process 1 is shown in FIG. 5

Process 2 determines from another set of the fields and data in the database related to the predetermined criteria whether or not the transaction as represented by the data in that another set of fields complies with the said predetermined criteria thereby indicating whether or not the transaction is a candidate for currency conversion. In this example, the another set of fields is fields 72, 52a, and the BIC of the sender in the header.

Process 3 identifies from a further set of the fields and related data in the database concerning the beneficiary whether or not the transaction is a candidate for currency conversion to carry out the currency conversion. In this example the further set of fields is fields 59a and 57a.

An example of processes 2 and 3 is shown in FIGS. 6, 7 and 8.

If all three processes indicate the transaction is a candidate for currency conversion, then currency conversion is carried out.

Process 1.

Referring to FIGS. 2, 4 and 5, process 1 is carried out at the US branch 10 of the intermediary. As shown in column A of FIG. 4 the US bank 2 sends a SWIFT message to the US branch 10 giving the following details:

| | | US Bank |
|---|---|---|
| Field | Content | To US Branch |
| Header | BIC of sender | Bank 1 |
| | | US |
| | | 0Nxxx |
| Header | BIC of receiver | Branch 1 |
| | | US |
| | | 1Nxxx |
| 23E | Payment code words | |
| 32A | Value date, | Date |
| | Currency, | USD |
| | Payment value | 1010 |
| 33B | Original currency, | USD |
| | Original amount | 1010 |
| 36 | Exchange rate | |
| 50a | Ultimate ordering | Transferor e.g. |
| | Party | Customer of US Bank |
| 52a | Ordering BIC | Bank 1 |
| (A or D) | (including country | US |
| | Code) | 1 |
| | | 0Nxxx |
| 56 | Intermediary BIC | |
| 57a | Destination Account | BNKX |
| (A, B, C, D) | holding Institution | GB2L |
| 59a A | Beneficiary | 12345678 |
| | Account number (including | GB |
| | Country code) | |
| 71 | Details of charges | |
| 72 | Service code | FX/GBP |
| | words | |

Referring to the flow chart of FIG. 5, the message is received at step S2.

At step S4, the data of field 57 is analysed to determine whether the content is A -a valid BIC code. If the content is not A (a valid BIC code), then at step S20 the process is stopped and the transaction of the message is not a candidate for conversion.

If the content is A then at step S6 if field 56 is empty (i.e. an intermediary is NOT indicated) the process continues to step S8. If field 56 is not empty then at steps S62 and S64 it is determined whether the content is a BIC of a bank which is not located in a country the currency of which is the same as the payment currency; in this example the currency of the bank indicated in field 56 is not USD (and thus currency conversion may be needed). If that is the case then the process proceeds to step S8. Otherwise (if the currency of the country of the bank is the same (e.g. USD) as the payment currency the process ends at step S20.

At steps S6, S62 and S64, if field 56 contains the BIC of a particular bank the message may be routed to that bank,

At step S8 if field 23E contains certain code words, the process ends at step S20. The code words are for example SDVA, INTC, CORT, CHQB, where SDVA is Same Day Value; INTC: Intra-company; CORT: Corporate activity such as Trade, securities etc.; and CHQB: is Pay via Cheque. otherwise it proceeds to step S10. At step S10, if field 36 is not empty (implying a currency conversion has already occurred) then the process ends at step S20, otherwise it proceeds to step S12.

Step S12 determines whether the currency in field 33B is the same as the currency in field 32A. If they are different that implies currency conversion has already taken place and the process ends at step S20. Otherwise the BIC of the sender is changed to that of the US branch, the BIC of the receiver is changed to that of the conversion branch 12, predetermined code words are added to the field 72 and the amended message as set out in column B of FIG. 4 is sent to the conversion branch 12. In this example the code words added to field 72 will be described in more detail below in the section headed “Field 72 code words”.

It will be appreciated that the steps S4 to S12 and steps S62 and S64 may be carried out in a different order.

Process 2 (FIGS. 2, 4, 6 and 7)

In process 2, the SWIFT message of column B of FIG. 4 is received by the conversion branch 12 at step S28. Referring to FIG. 6, data in the database 44 relating to a relevant contract is identified in step S22 from either the BIC of the ordering party in field 52 or the BIC of the sender in the header. Step S24 accesses the appropriate data which in step S26 is compared with data in the message as shown in FIG. 7.

Referring to step S30, the content of field 72 is examined. The bank having the contract is allowed to put predetermined code words in that field. Code words allowed in this example are /NOFX/, /FX/ and /FX/CCY/; FIG. 4 shows /FX/CCY/. If the code is /NOFX/ meaning the ordering bank does not want currency conversion to occur, then the process is terminated at step S32 and no currency conversion takes place. If field 72 does not contain /NOFX/ then at step S34 it is determined if the content of field 52 indicates the ordering BIC equals the accessed contract BIC or at step S36 the sending BIC equals the contract BIC. One or the other will be true and the process proceeds to step S38 where it is determined if the payment currency of field 32A is the same as the contract currency; i.e. whether the contract supports conversion from that currency if conversion is needed. If the payment currency is not supported then the process is terminated at step S40 and no currency conversion takes place. Otherwise the process proceeds to step S44 where it is determined if the payment value of field 32A is less than or equal to a maximum value specified in the contract. If the maximum value is exceeded then the process is terminated at step S40 and no currency conversion takes place. Otherwise the process proceeds to step S44 where the contents of field 72 are examined to determine if it contains /FX/CCY/ (a requirement to convert to currency CCY and if so step S52 is carried out. If not, at step S46 it is determined if field 72 contains /FX/ (a requirement to carry out currency conversion) or at step S48 if field 72 contains a default flag indicating a requirement to carry out currency conversion by default in accordance with the contract data set out in contract database 71. At step S52 (see also box 73 in FIG. 7) it is determined if the currency CCY of field 72 is the same as the destination currency identified from the contract and at step S54 it is determined whether the destination country of field 57a is the same as the destination country identified from the contract and data in a table T1 stored in the database. If steps S48 and S54 return negative answers then the process is terminated at step S50 and no currency conversion takes place. Otherwise the process continues as process 3.

Process 3

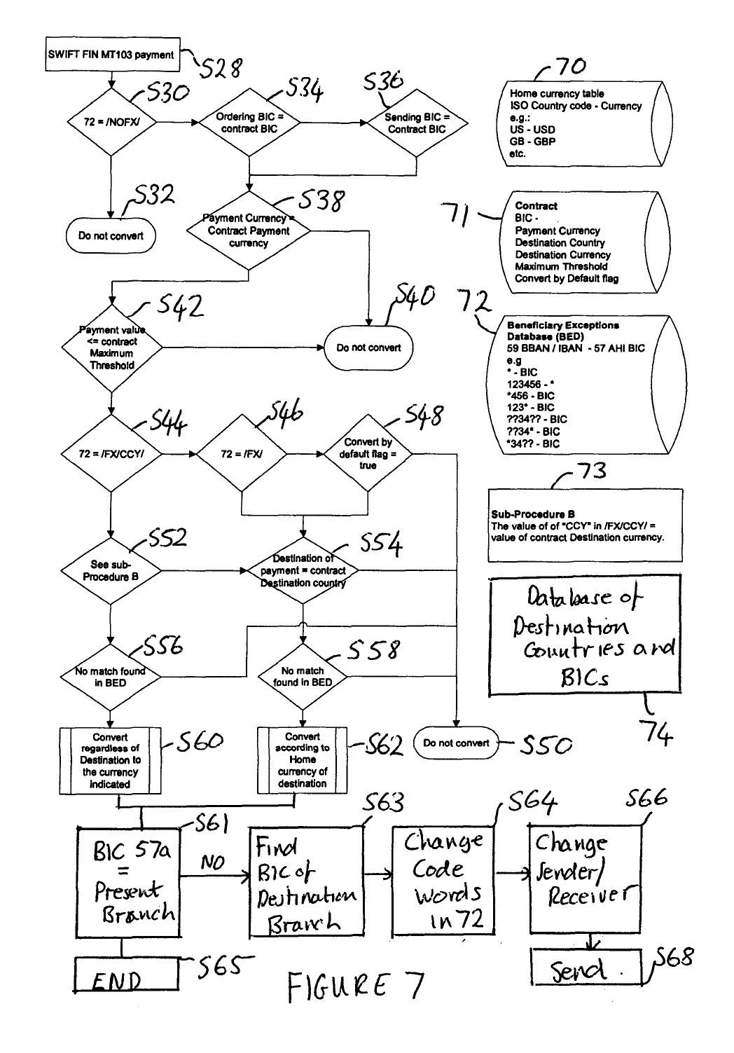

Step S52 of process 2 is followed by step S56 of process 3 and step S54 of process 2 is followed by step S58 of process 3. Steps S56 and S58 are the same and are shown in FIG. 8. The beneficiary is identified in step S80 using the content of field 59 or the BIC of field 57A. Data relating to the beneficiary is accessed from a beneficiary exceptions database 72 of database 44. If a match with the content of the beneficiary exceptions database occurs then the process is terminated at step S50 and no currency conversion takes place. Otherwise currency conversion takes place.

If step S56 indicates no match is found then currency conversion takes place at step S60 to the currency indicated by /CCY/ in field 72 regardless of the destination. For example the US bank 2 may require payment to John Doe at the UK bank 6 in EUR even though the home currency for the UK is GBP.

If step S58 indicates no match is found then currency conversion takes place at step S62 to the home currency of the destination.

If the system is set up so that the conversion branch could be may be a beneficiary bank, then at step S61 determines if the BIC of field 57a is the BIC of the conversion branch. If so the procedure ends at step S65 with the beneficiary's account being credited. Otherwise, step S63 occurs. In some versions of the system the conversion branch would not be a branch dealing with beneficiaries.

The conversion branch 12 may remove, add or change code words in field 72 [at step S64.

In step S63 the data processor determines from a data table held in the data base the BIC code of the intermediary's branch in the destination country. That data table provides BICs of branches in all the countries served by the system of FIG. 1. The data processor changes the sender BIC and receiver BIC of the header in step S66. In this example the sender BIC is changed to the BIC of the conversion branch and the BIC of the receiver is changed to the BIC of the UK Branch 14. The data processor and communications hardware and in step S68 send the amended message shown in column C to the UK branch 14 of the intermediary 4.

The UK branch 14 receives the message, changes the sender and receiver BICs in the header and sends the message as shown in column D of FIG. 4 to the UK bank 6. The reason for using the UK branch is to facilitate the corresponding transfer of value to the UK bank.

Field 72 Code Words

Step S16 carried out at the US branch of the intermediary adds code words to the field 72. Those code words are instructions to the other branches of the intermediary controlling the actions they take. For example the code words prevent the branches 12 and 14 from taking fees from the transferred money; in the first example only the US branch takes such a fee as is indicated in field 71 which is changed by the US branch 10 of the intermediary. Rules governing taking of fees are specified by the intermediary. An example of such a rule is that the first branch of a chain of branches involved in a transaction takes the fee but none of the others takes a fee. The code words added to field 72 are read by the data processors 40, 46 at the branches and control their actions.

Transfer of Value

Referring to FIG. 1, reference “A” beneath the block diagram of the system indicates the transfer of value when currency conversion occurs. Value is transferred as indicated by line 26 from the US bank 2 to the US branch 10 in known manner for example using the local clearing system. Likewise value is transferred from the UK branch 14 to the UK bank 6 in known manner using the local clearing system as indicated by line 32.

As indicated by lines 28 and 30 value is transferred between the branches 12 and 14 in known manner.

Reference “B” beneath the block diagram of the system indicates the transfer of value when currency conversion does not occur because process 1 done at branch 10 indicates currency conversion in not appropriate. In that case local clearing occurs as indicated at 34 between US bank 2 and local branch 10 and local branch 10 directly forwards the message as indicated at 36 to the UK beneficiary bank 6. Similar action would be taken by branch 12 if process 2 or 3 done at branch 12 indicates currency conversion in not appropriate.

### Example 2

### FIG. 9

Referring to FIG. 9, example 2 differs from example 1 in that the US bank 2 communicates directly with the conversion branch 12 of the intermediary as indicated by line 261 because the US bank has a banking relationship with the conversion branch. The conversion branch carries out the processes 1, 2 and 3 described above to determine whether conversion is appropriate. If conversion is not appropriate then the transaction is sent to the US branch 10 as indicated by 264 and the US branch forwards the transaction to the beneficiary's bank 6 as indicated by line 266. If conversion is appropriate then the conversion branch sends the transaction to the UK branch 14 as indicated by line 281 and the UK branch sends it to bank 6 as indicated by line 321. The messages of FIG. 4 are changed as needed. As described above the conversion branch itself could be the beneficiary's bank or the UK branch could be the beneficiary's branch and if so the transaction is dealt with as described above for those circumstances.

Beneficiary Exceptions Database

The beneficiary exceptions database is populated with data concerning beneficiaries of transactions in which currency conversion should not take place. In the examples described above the data comprises data relating to beneficiary's account numbers which can include complete account numbers, incomplete account numbers and account numbers including “wild cards” for example
123456-*, *456, 123*, ??34??, etc.

In an example of a beneficiary database, the database is includes BICs or BEIs of certain Financial Institutions or types of Financial Institution which are known to not need, or want, an intermediary to deal with currency conversion for them. The database may contain parts of BEIs and BICs using wild cards for example
.BNKXGB2LXXX, BNKXGB2L*, BNKXGB*, etc.

The database is updated when transactions involving currency conversion as described above are rejected and the intermediary is notified of the rejection. The updating may be automatic or manual.

Computer Programs

It will be appreciated that the present examples of the invention use programmable data processors 44 and 46 for automatically implementing the processes of the invention. Accordingly, the invention includes computer programs, indicated schematically at 41 in FIGS. 3B and 47 in FIG. 3A, which when run on suitable data processing systems implement the processes described above. The programs may include programs which implement parts of the overall process for example process 1 may be implemented by one program run on the processor of the US branch 10 and processes 2 and 3 may be implemented by programs run on the processor of the conversion branch.

A program may be: provided via a network; carried on a signal; stored on a server; or stored on carrier such as a computer readable medium. Examples of computer readable media are CDs, DVDs, Blu-Ray™ discs, hard disc drives and electronic memory for example flash memory, magnetic discs, magneto-electric discs or any other suitable media.

Variants.

The systems and processes described above by way of example may be modified.

The beneficiary bank may be one of the branches of the intermediary. For example the conversion branch may itself be the beneficiary bank. As another example the UK branch 6 or any of the other branches of the intermediary may be the beneficiary bank.

The US branch 2 and/or any of the branches C2Br., C3Br. which receives a transaction from a country bank may have a data processor arranged to carry out not only the first process described above with reference to FIG. 5 but also simplified versions of, or parts of the processes 2 and 3. For example the US Branch 10 may carry out steps S28 to S42 which involve checking the payment currency is the contract currency and the value is less than or equal to the maximum threshold. The conversion branch 12 may then carry out the whole process of FIG. 7 even though part has been done by the US branch or may carry out the part(s) not done by the US branch.

1-24. (canceled)

25. A data processing system for processing coded data having a plurality of data fields representing a financial transaction potentially involving currency conversion, the system comprising:
a data processing arrangement including a database containing data relating to beneficiaries of financial transactions and other predetermined criteria;
a communications interface arrangement for interfacing with a secure financial communications system for transmitting coded data from the data processing arrangement to the communication system and transmitting coded data from the communications system to the data processing arrangement;
the data processing arrangement being arranged to
analyse the data fields of coded data received from the communications system,
identify from the analysed coded data fields and data in the database whether the transaction complies at least with the predetermined criteria and criteria relating to the beneficiary whether or not to carry out currency conversion;
if currency conversion is to be carried out, change data in the data fields relating to the currency and value of the currency and, whether or not currency conversion is carried out, change data in data fields relating to the addressing of the coded data; and
send the coded data as so changed to the communications interface arrangement for transmission via the secure communications system to the address specified in the data fields relating to the addressing of the coded data.

26. A system according to claim 25, wherein the data processing arrangement is arranged to identify from the analysed coded data fields and data in the database whether to carry out currency conversion by:
identifying from a one set of the fields and data in the database related to the said other predetermined criteria whether or not the transaction as represented by the data in that one set of fields complies with the said predetermined criteria thereby indicating whether or not the transaction is a candidate for currency conversion.

27. A system according to claim 25, wherein data processing arrangement is arranged to identify from the analysed coded data fields and data in the database whether to carry out currency conversion by:
identifying from a set of the fields and related data in the database concerning the beneficiary whether or not the transaction is a candidate for currency conversion to carry out the currency conversion.

28. A system according to claim 25, wherein the data processing arrangement is arranged to identify from the analysed coded data fields and data in the database whether to carry out currency conversion by:
identifying from a set of the fields relating to the currency involved in the transaction and to fields relating to the destination account holding institution whether or not the transaction is a candidate for currency conversion.

29. A system according to claim 25, wherein the said data processing arrangement comprises a data processor arranged to identify from the analysed coded data fields and data in the database whether to carry out currency conversion by:
identifying from a set of the fields relating to the currency involved in the transaction and to a field of the set relating to the destination account holding institution whether or not the transaction is a candidate for currency conversion;
establishing from data relating to said predetermined criteria stored in the data base and a related set of fields whether the candidate complies with the said predetermined criteria; and
determining from data in the database relating to the beneficiary and the relevant fields whether or not currency conversion is excluded by virtue of the data relating to the beneficiary.

30. A data processing system according to claim 25, wherein the data processing arrangement and the communications interface arrangement comprises:
a first data processor and a communications interface for interfacing with the secure financial communications system for transmitting coded data from the first data processor to the communication system and transmitting coded data from the communications system to the first data processor, the first data processor being arranged to identify from a set of the fields relating to the currency involved in the transaction and to fields relating to the destination account holding institution whether or not the transaction is a candidate for currency conversion and, having established the transaction is such a candidate; change data in data fields relating to the addressing of the coded data; and send the coded data as so changed to the communications interface for transmission via the secure communications system to the address specified in the data fields relating to the addressing of the coded data; and,
at the said address provided by the first data processor, a second data processor including the said database containing data relating to beneficiaries of financial transactions and other predetermined criteria and having a further communications interface for interfacing with the secure financial communications system;
the second processor being operable to receive from the first processor via the secure communications system the said coded data produced by the first processor representing the candidate,
further establish from data relating to said predetermined criteria stored in the data base and the data of the relevant fields whether the candidate complies with the said criteria,
determining from data in the database relating to the beneficiary and the relevant fields, whether or not to carry out currency conversion,
carry out currency conversion if the candidate complies with the said predetermined criteria and criteria relating to the beneficiary,
if currency conversion is carried out, change data in the data fields relating to the currency and value of the currency and, whether or not currency conversion is carried out, change data in data fields relating to the addressing of the coded data; and
send the coded data as so changed to the further communications interface arrangement for transmission via the secure communications system to a further address specified in the data fields relating to the addressing of the coded data.

31. A system according to claim 30, wherein the first data processor is arranged to add, to a predetermined field of the coded data, data representing instructions to the second processor.

32. A system according to claim 25, wherein the data processing arrangement comprises a first plurality of data processors each having a communications interface for interfacing with the secure financial communications system for transmitting coded data from the first data processor to the communication system and transmitting coded data from the communications system to the first data processor, each of the data processors of the first plurality being arranged to identify from a set of the fields relating to the currency involved in the transaction and to fields of the first set relating to the destination account holding institution whether or not the transaction is a candidate for currency conversion and, having established the transaction is such a candidate, change data in data fields relating to the addressing of the coded data, and send the coded data as so changed to the communications interface for transmission via the secure communications system to a predetermined address which is specified in the data fields relating to the addressing of the coded data; and,
at the said predetermined address, a further data processor having a communications interface operable to receive coded data from all the data processors of the said first plurality for processing coded data relating to any candidate transaction received from the first plurality of processors,
the further data processor including the said database containing data relating to beneficiaries of financial transactions and other predetermined criteria
the further processor being arranged to process each received candidate transaction to establish from data relating to said predetermined criteria stored in the data base and data of one set of relevant fields whether the candidate complies with the said criteria,
determining from another set of fields and data in the database relating to the beneficiary, whether or not to carry out currency conversion,
carry out currency conversion if the one and another sets of fields indicate the transaction is a candidate for currency conversion,
if currency conversion is carried out, change data in the data fields relating to the currency and value of the currency and, whether or not currency conversion is carried out, change data in data fields relating to the addressing of the coded data; and
send the coded data as so changed to the further communications interface arrangement for transmission via the secure communications system to a further address specified in the data fields relating to the addressing of the coded data.

33. A system according to claim 32, further comprising a second plurality of data processors each having a communications interface, each data processor of the second plurality having a communications interface operable to receive coded data relating to a transaction sent by the further processor to it, each processor of the second plurality being arranged to process the transaction sent to it.

34. A data processing system for processing coded data having a plurality of data fields representing a financial transaction potentially involving a currency conversion, the system comprising:
a data processor and a communications interface for interfacing with the secure financial communications system for transmitting coded data from a first data processor to the communication system and transmitting coded data from the communications system to the first data processor, the said data processor being arranged to identify from a set of the fields relating to the currency involved in the transaction and to fields of the first set relating to the destination account holding institution whether or not the transaction is a candidate for currency conversion, and having established the transaction is such a candidate change data in data fields relating to the addressing of the coded data; and send the coded data as so changed to the communications interface for transmission via the secure communications system to the address specified in the data fields relating to the addressing of the coded data.

35. A data processing system for processing coded data having a plurality of data fields representing a financial transaction potentially involving a currency conversion, comprising:
a data processor including a database containing data relating to beneficiaries of financial transactions and other predetermined criteria and having a further communications interface for interfacing with the secure financial communications system for transmitting coded data from the data processor to the communication system and transmitting coded data from the communications system to the data processor;
the data processor being operable to receive from the another processor via the secure communications system the said coded data representing the candidate transaction;
establish from data relating to said predetermined criteria stored in the data base and a set of fields whether the candidate transaction complies with the said criteria and is thus a candidate for currency conversion,
having established the candidate complies with the criteria, determining from a set of fields and data in the database relating to the beneficiary, whether or not to carry out currency conversion, and
carry out currency conversion if the sets of fields indicate the transaction is a candidate for currency conversion.

36. A system according to claim 35, wherein the data processor is further arranged, if currency conversion is carried out, to change data in the data fields relating to the currency and value of the currency and, whether or not currency conversion is carried out, change data in data fields relating to the addressing of the coded data; and
send the coded data as so changed to the further communications interface arrangement for transmission via the secure communications system to a further address specified in the data fields relating to the addressing of the coded data.

37. A non-transitory computer-readable storage medium or set of such media having computer readable instructions stored thereon, the computer readable instructions being executable by a computerized data processing system to cause the system to perform a method of processing a financial transaction which may or may not involve a currency conversion, the method using an intermediary having a data processing arrangement including a database containing data relating to beneficiaries of financial transactions and other predetermined criteria and a communications interface for interfacing the data processing arrangement with a secure financial communications system whereby the intermediary can receive coded data from an originator of coded data and send coded data, the data processing system of the intermediary carrying out the steps of:
analysing the data fields of coded data received from the communications system,
identifying from one set of the fields and data in the database whether or not the transaction complies with at least the said predetermined criteria;
if currency conversion is carried out, changing data in the data fields relating to the currency and value of the currency and, whether or not currency conversion is carried out, change data in data fields relating to the addressing of the coded data to readdress the coded data to another data processing system; and
sending the coded data as so changed to the communications interface arrangement for transmission via the secure communications system to the address specified in the data fields relating to the addressing of the coded data.

38. A non-transitory computer-readable storage medium or set or such media having computer readable instructions stored thereon, the computer readable instructions being executable by a data processing system having a data processor including a database containing data relating to beneficiaries of financial transactions and other predetermined criteria and having a further communications interface for interfacing with a secure financial communications system for transmitting coded data from the data processor to the communication system and transmitting coded data from the communications system to the data processor to cause the computerized device to perform a method of processing coded data having a plurality of data fields representing a financial transaction potentially involving a currency conversion, the data processor being operable to receive from another processor via the secure communications system the said coded data representing the candidate transaction;
the method comprising:
establishing from data relating to said predetermined criteria stored in the data base and a set of fields whether the candidate transaction complies with the said criteria and is thus a candidate for currency conversion,
having established the candidate complies with the criteria, determining from a set of fields and data in the database relating to the beneficiary, whether or not to carry out currency conversion, and
carrying out currency conversion if the sets of fields indicate the transaction is a candidate for currency conversion.

39. A method of processing a financial transaction which may or may not involve a currency conversion, the method using an intermediary having a data processing arrangement including a database containing data relating to beneficiaries of financial transactions and other predetermined criteria and a communications interface for interfacing the data processing arrangement with a secure financial communications system whereby the intermediary can receive coded data from an originator of coded data and send coded data, the data processing system of the intermediary carrying out the steps of:—
analysing the data fields of coded data received from the communications system,
identifying from one set of the fields and data in the database whether or not the transaction complies with at least the said predetermined criteria;
if currency conversion is carried out, changing data, in the data fields relating to the currency and value of the currency and, whether or not currency conversion is carried out, change data in data fields relating to the addressing of the coded data to readdress the coded data to another data processing system; and
sending the coded data as so changed to the communications interface arrangement for transmission via the secure communications system to the address specified in the data fields relating to the addressing of the coded data.

40. A method according to claim 39, wherein the coded data is readdressed to a data processor at a financial institution holding the account of the beneficiary.

41. A method according to claim 39, wherein the data processing system of the intermediary carries out the steps of
identifying from a set of the fields relating to the currency involved in the transaction and to fields of the first set relating to the destination account holding institution whether or not the transaction is a candidate for currency conversion;
having established the transaction is such a candidate, further establishing from data relating to said predetermined criteria stored in the data base and the first set of fields whether the candidate complies with the said criteria; and
having established the candidate complies with the criteria, determining from the second set of fields and data in the database relating to the beneficiary, whether or not to carry out currency conversion;
if currency conversion is carried out, changing data in the data fields relating to the currency and value of the currency and, whether or not currency conversion is carried out, changing data in data fields relating to the addressing of the coded data to readdress the coded data to a computer system in another branch of the intermediary; and
sending the coded data as so changed to the communications interface arrangement via the secure communications system to the address specified in the data fields relating to the addressing of the coded data.

42. A method according to claim 41, comprising adding to a data field of the coded data instructions to the computer system of the said another branch.

43. A method according to claim 42, wherein the said instructions relate to payment of fees for processing the transaction.

44. A method according to claim 39, wherein the intermediary comprises at least first, second and third branches,
the first and third branches each comprising a computer system and a communications hardware for interfacing with the secure financial communications system for transmitting coded data from the computer system to the communication system and transmitting coded data from the communications system to the computer system,
the second branch including a computer system including a database containing data relating to beneficiaries of financial transactions and other predetermined criteria and communications hardware for interfacing with the secure financial communications system for transmitting coded data from the computer system to the communication system and transmitting coded data from the communications system to the computer system,
the computer system of the first branch carrying out the steps of
the identifying from a set of the fields relating to the currency involved in the transaction and to fields of the first set relating to the destination account holding institution whether or not the transaction is a candidate for currency conversion, and having established the transaction is such a candidate changing data in data fields relating to the addressing of the coded data to the address of the computer system of the second branch; and sending the coded data as so changed to the communications interface for transmission via the secure communications system to the address specified in the data fields relating to the addresing of the coded data; and
the computer system of the second branch receiving the said coded data produced by the computer system of the first branch,
establishing from data relating to said predetermined criteria stored in the data base and the first set of fields whether the candidate complies with the said criteria,
having established the candidate complies with the criteria, determining from the second set of fields and data in the database relating to the beneficiary, whether or not to carry out currency conversion,
carrying out currency conversion if the second set of fields indicates the transaction is a candidate for currency conversion,
if currency conversion is carried out, changing data in the data fields relating to the currency and value of the currency and, whether or not currency conversion is carried out, changing data in data fields relating to the addressing of the coded data to the address of the computer system of the third branch; and
sending the coded data as so changed to the further communications interface arrangement for transmission via the secure communications system to the third branch;
the computer system of the third branch readdressing the coded data to the beneficiary's bank.

45. A method according to claim 44, wherein the first branch adds instructions to the second branch to a data field of the coded data.

46. A method according to claim 44, wherein the first branch is located in the country of the originator, and the third branch is located in the country of the beneficiary.
